(19) United States
(12) Patent Application Publication
(10) Pub. No.: US 2011/0270594 A1
(43) Pub. Date: Nov. 3, 2011

(54) Predicting A Compaction Point Of A Clastic Sediment Based on Grain Packing

(76) Inventor: Mark A. Rudnicki, Woodlands, TX (US)

(21) Appl. No.: 13/142,562

(22) PCT Filed: Dec. 3, 2009
(86) PCT No.: PCT/US09/66604

§ 371 Date: Jun. 28, 2011

(51) Int. Cl. G06F 17/10; G06F 7/60

(52) U.S. Cl. 703/2

(57) ABSTRACT

An end compaction point of a clastic sediment within a subsurface region is predicted by establishing a first grain size distribution, wherein the first grain size distribution is a measured grain size distribution, or a predicted grain size distribution. A discrete element model of the subsurface region is initialized, wherein the model comprises a model volume including a base, periodic horizontal boundaries, and soft objects representative of particles of the first grain distribution at a predetermined porosity. A final packing state of the clastic sediment is predicted by iteratively running the model, wherein the final packing state of the clastic sediment is based on packing of the soft objects with a pack and based on the first grain size distribution, wherein soft objects within the model are capable of overlapping with adjacent soft objects within the model.

### CROSS-REFERENCE TO RELATED APPLICATION

This application claims the benefit of U.S. Provisional Patent Application 61/152,511 filed 13 Feb. 2009 entitled PREDICTING A COMPACTION POINT OF A CLASTIC SEDIMENT BASED ON GRAIN PACKING, the entirety of which is incorporated by reference herein.

### TECHNICAL FIELD

This description relates generally to oil and gas exploration and production, and more particularly to one or more techniques for predicting an end compaction point of a clastic sediment based on grain rearrangement, e.g., grain packing, and utilizing the predicted end compaction point to characterize the porosity of a subsurface region.

### BACKGROUND ART

Predicting the compaction of clastic sediments, e.g., sediments composed of a framework of grains, is a fundamental concern of the oil and gas industry. Compaction reduces the porosity of a potential reservoir, thereby limiting the stored resource. The space between the grains is often referred to as the “intergranular volume” (IGV). When fully compacted, the sediment achieves a minimum intergranular volume, termed IGV_{f} (final intergranular volume). For example, the publication by Lander and Walderhaug, entitled “Predicting porosity through simulating sandstone compaction and quartz cementation,” Amer. Assoc. Petrol. Geol. Bull., 83, 433-449, 1999 refers to intergranular volume. However, IGV differs from porosity in that porosity may be reduced by pore filling cements and by clay matrix, in addition to compaction. For sediment with no cements and no matrix, the IGV and intergranular porosity are equivalent.

As suggested by Grier and Marschall, in the publication entitled “Reservoir Quality: Part 6. Geological Methods” in “ME 10: Development Geology Reference Manual”, AAPG Special Publication, 275-277 (1992), the compaction of clastic sedimentary rocks is often considered to include the following processes: grain rearrangement, ductile grain deformation, grain breakage, and grain dissolution either at point contacts (pressure solution) or through stylolitization.

Of these four processes, the first—grain rearrangement—achieves porosity loss through grain packing, without physical grain alteration. The last three processes—ductile grain deformation, grain breakage and grain dissolution—achieve porosity reduction through physical and chemical grain alteration. In the present application, the prediction of the end compaction point, e.g., final intergranular volume, or IGV_{f}, for a clastic sediment is determined by considering the process of grain rearrangement.

Previous solutions to predicting the loss of porosity due to compaction have relied on fitting empirical curves to measured data as a function of depth or effective stress, see, e.g., Athy, L. F., “Density, porosity and compaction of sedimentary rocks,” Amer. Assoc. Petrol. Geol. Bull., 14, 1-24 (1930). Since the formation of diagenetic cements may reduce porosity at all stages of burial, Paxton et al. (1990) have suggested using IGV as a measure of the compaction of a sediment. See, e.g., Paxton, S. T., J. O. Szabo, C. S. Calvert and J. M. Ajdukiewicz, “Preservation of primary porosity in deeply buried sandstones: a new play concept from the Cretaceous Tuscaloosa Sandstone of Louisiana (Abstract),” Amer. Assoc. Petrol. Geol. Bull., 74, 737 (1990). Subsequently, Paxton et al. (2002) published IGV based compaction curves. See, e.g., Paxton, S. T., J. O. Szabo, J. M. Ajdukiewicz and R. E. Klimentidis, “Construction of an intergranular volume compaction curve for evaluating and predicting compaction and porosity loss in rigid-grain sandstone reservoirs,” Amer. Assoc. Petrol. Geol. Bull., 86, 2047-2067 (2002).

Based on some of this work, Lander and Walderhaug (1999) proposed the general compaction function:

$$\frac{d IGV}{d {σ}_{es}} = - β \qquad ( Equation 1 a )$$

which has the solution:

IGV=IGV_{f}+(IGV₀−IGV_{f})e^{-βσ}^{ₑₛ} (Equation 1b)

where:

### IGV=IGV at σₑₛ

IGV_{f}=final stable IGV
IGV₀=initial IGV at deposition
σₑₛ=effective stress (MPa)
β=compaction rate constant (MPa⁻¹)
Lander and Walderhaug (1999) proposed that the final compaction state defined by IGV_{f} should be empirically calibrated for specific sandstone compositions and textures.

However, the present inventor has determined that compaction curves based on empirical calibrations are not fundamentally predictive. For example, predictions of packing based on IGV_{f}-sorting relationships may break down when the sediment grain size distribution is not log-normal. The present inventor has also determined that methods to predict packing based on hard spheres also tend to overpredict the porosity of natural sediments.

### SUMMARY

One or more of the exemplary embodiments of the present invention support making decisions, plans, strategies, and/or tactics for developing and managing petroleum resources, such as a petroleum reservoir. One or more of the exemplary embodiments described in greater detail hereinafter may be utilized to assist in reservoir evaluation, development planning, and/or reservoir management. For example, reservoir evaluation may include an evaluation of the size and/or quality of the reservoir, including reservoir characterization, development planning may include deciding the size, timing, and/or location of surface facilities to build and/or install on site, and reservoir management may include deciding how to operate or manage the field, e.g., rate/pressure settings, wells to work over, and/or infills to drill.

In one general aspect, a method for predicting an end compaction point of a clastic sediment within a subsurface region includes establishing a first grain size distribution. The first grain size distribution is a measured grain size distribution, a predicted grain size distribution, or a combination of a measured and predicted grain size distribution. A discrete element model of the subsurface region is initialized. The model includes a model volume having a base, horizontal boundaries, and soft objects representative of particles of the first grain distribution at a predetermined porosity. A final packing state of the clastic sediment is predicted by iteratively running the model, wherein the final packing state is based on packing of the soft objects with a pack and based on the first grain size distribution. The soft objects within the model are capable of overlapping with adjacent soft objects within the model.

Implementations of this aspect may include one or more of the following features. For example, iteratively running the model may include calculating elastic contact forces and summing elastic contact forces for each particle. The soft objects may be representative of one or more grains and/or may be permitted to overlap to a predetermined degree with adjacent soft objects. The running of the model may include calculating a compacting force due to gravity for each particle in the model. The running of the model may include calculating a compacting force due to gravity for each particle in the model. The running of the model may include balancing compacting forces with the elastic forces at grain contacts to achieve a predetermined packing stability. The compacting forces may be balanced with the elastic forces at grain contacts to achieve a predetermined packing stability. With a full stability condition, the packing stability of each object may be determined by checking all points of contact below the mid point of the soft object in order to assess whether the soft object is fully supported.

With a reduced stability condition, only the three lowermost contact points of each object may be examined to determine whether the three lowermost contact points constitute a supporting configuration for each soft object. The predetermined packing stability may be a selected model condition. A full stability condition or a reduced stability condition may be selected for generating a random close packing with the model.

The porosity over a specified section of the pack may be calculated for each iteration of the model run, wherein porosity is calculated as a function of grain size distribution and based on the final packing state. The calculated porosity over the specified section of the pack may be stored for each iteration of the model run. The specified section of the pack for which porosity is calculated may range from 0.2 fraction of the pack height to 0.45 fraction of the pack height to avoid the effects of base and top boundary conditions.

The model may be run for a specified number of iterations. For example, the specified number of iterations may be approximately 25,000 iterations or less, or more preferably may be 2500 iterations or less. The method may include recording the minimum porosity and conditions of the pack at the minimum porosity at each iteration while running the model. A fraction of total object overlap volume may be set for at least one of the iterations, e.g., all of the iterations or individually for each of the iterations. The soft objects may include soft spheres, soft cells, or soft polyhedrons, and the fraction of total object overlap volume is set at 0.05 or less. The model volume may include a solid base, periodic horizontal boundaries, an open top, and soft spherical objects representative of particles of the first grain distribution at a predetermined initial porosity.

In another general aspect, a method of determining a volume of hydrocarbons within a subsurface region includes determining an end compaction point of a clastic sediment within a subsurface region. Predicting the end compaction point includes establishing a first grain size distribution, wherein the first grain size distribution is a measured grain size distribution or a predicted grain size distribution; initializing a discrete element model of the subsurface region, wherein the model comprises a model volume comprising a base, horizontal boundaries, and soft objects representative of particles of the first grain distribution at a predetermined porosity; and predicting, by iteratively running the model, a final packing state of the clastic sediment based on packing of the soft objects with a pack and based on the first grain size distribution, wherein soft objects within the model are capable of overlapping with adjacent soft objects within the model. A maximum available porosity capable of containing hydrocarbons in the clastic sediment is determined based on the determined end compaction point. A maximum porosity of the sediment is determined at a plurality of depths in the subsurface region using an initial compaction porosity and a final predicted compaction porosity, and compaction laws. A hydrocarbon volume is estimated within the subsurface region based on the determined maximum porosity.

In another general aspect, a tangible computer-readable storage medium includes embodied thereon a computer program configured to, when executed by a processor, predict an end compaction point of a clastic sediment within a subsurface region, the computer program being configured to establish a first grain size distribution, wherein the first grain size distribution is a measured grain size distribution or a predicted grain size distribution; to initialize a discrete element model of the subsurface region, wherein the model comprises a model volume comprising a base, horizontal boundaries, and soft objects representative of particles of the first grain distribution at a predetermined porosity; and to predict, by iteratively running the model, a final packing state of the clastic sediment based on packing of the soft objects with a pack and based on the first grain size distribution, wherein soft objects within the model are capable of overlapping with adjacent soft objects within the model.

Implementations of this aspect may include one or more of the following features. For example, the tangible computer-readable storage medium may include one or more code segments configured to perform one or more of the following functions. For example, the tangible computer-readable medium may include code segments configured to determine a volume of hydrocarbons within a subsurface region, to determine a maximum available porosity capable of containing hydrocarbons in the clastic sediment based on the determined end compaction point, to determine a maximum porosity of the sediment at a plurality of depths in the subsurface region using an initial compaction porosity and a final predicted compaction porosity, and compaction laws, and/or to estimate a hydrocarbon volume within the subsurface region based on the determined maximum porosity. The compaction laws may include exponential compaction with increasing depth or effective stress. A volume of producible hydrocarbons within the subsurface region may be estimated based on the estimated hydrocarbon volume from the computer program. Hydrocarbons may also be produced from the subsurface region based on the estimated volume of producible hydrocarbons from the computer program.

In one or more of the aforementioned aspects, the compaction laws may include exponential compaction with increasing depth or effective stress. A volume of producible hydrocarbons within the subsurface region may be estimated based on the estimated hydrocarbon volume. Hydrocarbons may be produced from the subsurface region based on the estimated volume of producible hydrocarbons.

### BRIEF DESCRIPTION OF THE DRAWINGS

FIG. 1 is a graphical view of modeled porosity plotted versus sorting for theoretical, experimental, and numerical modeling results of several techniques of the background art.

FIG. 2 is a graphical view comparing measured intergranular volume percentage plotted versus Folk sorting and the theoretical model depicted in FIG. 1.

FIG. 3 is a flowchart of an exemplary process for predicting final packing state of a clastic sediment.

FIG. 4 is a graphical view of predicted final intergranular volume plotted versus overlap volume for a test data set generated in accordance with the process of FIG. 3.

FIG. 5 are graphical views of exemplary grain size distributions for a given sorting value (Folk sorting parameter).

FIG. 6 is a graphical view of predicted final intergranular volume plotted versus measured intergranular volume.

FIG. 7 is a graphical view of intergranular volume plotted versus Folk sorting for results obtained by the process of FIG. 3, measured intergranular volume, and showing the log-normal trend.

FIGS. 8A-8D are screenshots depicting predicted packing states obtained after running a discrete element model for a variety of sequential iterations.

Many aspects of the exemplary embodiments can be better understood with reference to the above drawings. The elements and features shown in the drawings are not necessarily to scale, emphasis instead being placed upon clearly illustrating principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION

The present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

Certain steps in the methods and processes described herein must naturally precede others for one or more of the exemplary embodiments to function as described. However, the exemplary embodiments are not limited to the order of the steps described if such order or sequence does not adversely alter the functionality of the described method or process. That is, it is recognized that some steps may be performed before or after other steps or in parallel with other steps without departing from the scope and spirit of the present invention.

There are several fundamental controls on grain packing of clastic sediments. First, clastic sediments are composed of grains which have a diversity of sizes. Where hydrodynamic forces lead to continued sorting of such sediments, the grain size distribution will evolve to a log-normal distribution. In the simple case of log-normal (or approximately log-normal) grain size distributions, the stable packing state of the sediment may thus be parameterized as a function of the standard deviation of the grain size in log space. In sedimentology, the standard deviation of the grain size (in log₂ space) is known as the Folk sorting parameter. See, e.g., Folk, R. L., 1974, Petrology of Sedimentary Rocks: Austin, Hemphill Publishing Company, pp. 40-43.

Experiments on the packing of such log-normal grain packs, e.g., either of natural materials or synthetic, have shown that the porosity of the random close packing configuration decreases as the standard deviation of the grain size increases in log space. See, e.g., Sohn, H. Y. and C. Moreland, 1968, The effect of particle size distribution on packing density, Cam. J. Chem. Eng., 46, 1662-1667. Various publications by Nolan and Kavanagh used a numerical discrete element model (DEM) to investigate porosity trends with increasing grain size standard deviation in log space. See, e.g., Nolan, G. T. and P. E. Kavanagh, 1992, Computer simulation of random packing of hard spheres, Powder Technology, 72, 149-155; Nolan, G. T. and P. E. Kavanagh, 1993, Computer simulation of random packings of spheres with log-normal distributions, Powder Technology, 76, 309-316; and Nolan, G. T. and P. E. Kavanagh, 1994, The size distribution of interstices in random packings of spheres, Powder Technology, 78, 231-238.

Theoretical models have also been proposed to calculate the porosity of packs of polydisperse objects, e.g., many grain sizes, especially of spheres. For example, the publications by Ouchiyama, N, and T. Tanaka, 1981, Porosity of a mass of solid particles having a range of size, Ind. Eng. Chem. Fundam., 20, 66-71; Stovall, T., F. De Larrard and M. Buil, 1986, Linear packing density model of grain mixtures, Powder Tech., 48, 1-12; and Yu, A. B., and N. Standish, 1987, Porosity calculations of multi-component mixtures of spherical particles, Powder Tech., 52, 233-241, describe exemplary theoretical models for calculating porosity of packs of polydisperse objects. Typically, these methods calculate the minimum porosity of a random close packing of hard spheres given a grain size distribution. In the present application the term ‘hard’ refers to spheres and/or other objects, such as polyhedrons of a variety of number of sides, in a model that are non-overlapping. In the present application the term ‘soft” refers to spheres and/or objects, such as polyhedrons, that permit some degree of overlap. Soft spheres and/or other objects may be rigidly shaped and/or even partially deformable.

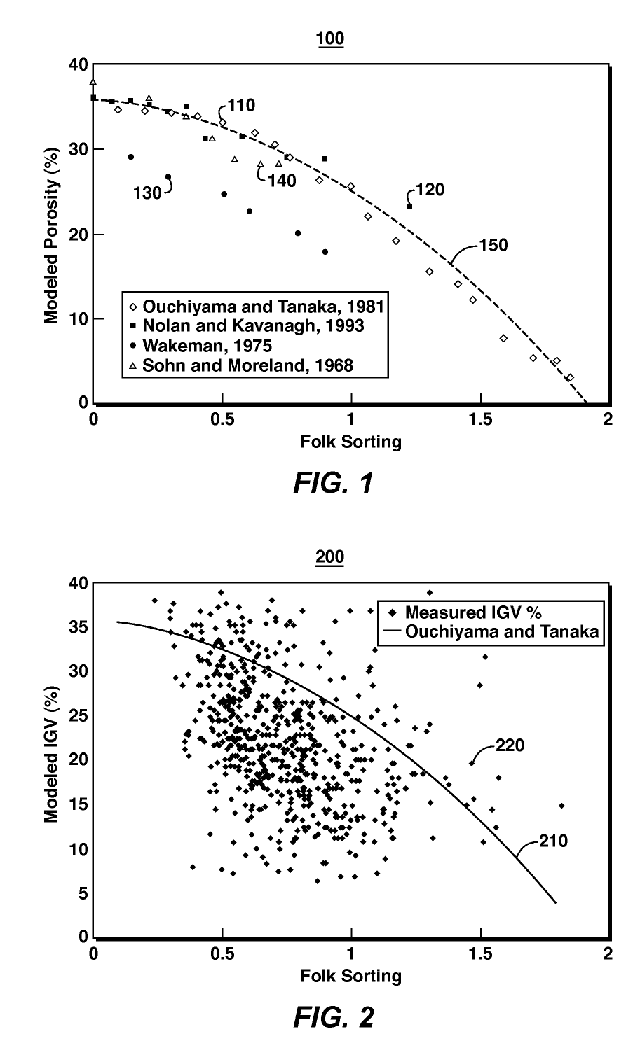

FIG. 1 is a graphical view of modeled porosity plotted versus sorting 100 for theoretical 110, experimental 140, and numerical modeling 120 results of several techniques of the background art. Referring to FIG. 1, the results from the Ouchiyama and Tanaka (1981) model 110 are in good agreement with the experimental work of Sohn and Moreland (1968) 140 and the modeling work of Nolan and Kavanagh (1993) 120. Specifically, FIG. 1 demonstrates the variation of modeled porosity versus sorting for theory (Ouchiyama and Tanaka, 1981) 110, multiparticle sand experiments (Sohn and Moreland, 1968) 140, multiparticle glass bead experiments (Wakeman, 1975) 130 and a numerical discrete element model (DEM) (Nolan and Kavanagh) 120. See, e.g., Wakeman, R. J., 1975, Packing densities of particles with log-normal size distributions, Powder Technology, 11, 297-299. A polynomial fit 150 has been applied to the Ouchiyama and Tanaka model, and scatter in the model results is due to discretizing the normal distribution 150. The present inventor has also determined that there is good agreement between theory, experiments (except for Wakeman's data) and numerical modeling. Specifically, sediment grain size distributions may be bi-modal, poly-modal or otherwise complex so that grain size distributions will not be adequately represented or parameterized by a log-normal distribution 150. In general, the present inventor has determined that the prediction of the stable packing state of the sediment will not be adequately parameterized as a function of Folk sorting.

Further, the relationships from these models may not be adequate to describe the packing of natural sediments. FIG. 2 is a graphical view 200 comparing measured intergranular volume percentage plotted versus Folk sorting 220 and the theoretical model 210 depicted in FIG. 1. Referring to FIG. 2, measured IGV versus Folk Sorting 220 is depicted in comparison to the Ouchiyama and Tanaka (1981) trend 210 depicted on FIG. 1. Specifically, a data compilation of measured IGV plotted together with Ouchiyama and Tanaka's relationship with sorting indicates that the IGV of natural sediment samples fall significantly below the prediction based on hard sphere packing.

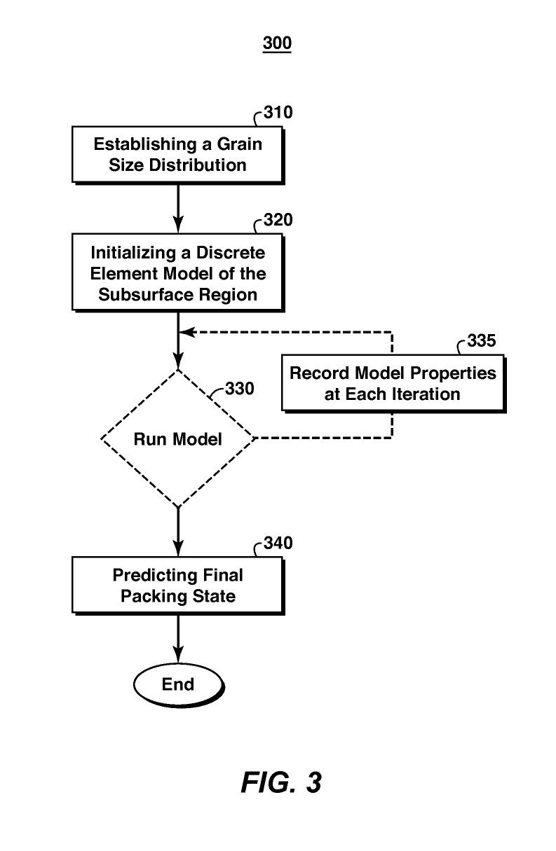

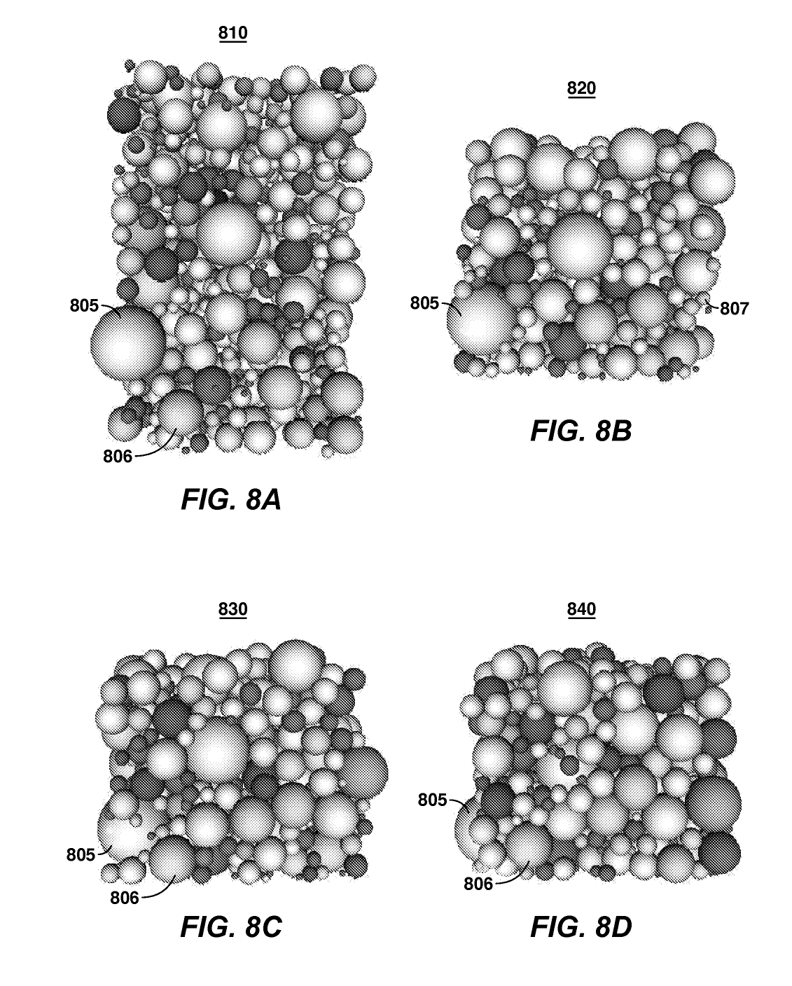

FIG. 3 is a flowchart of an exemplary process 300 for predicting final packing state of a clastic sediment. The present inventor has developed a process 300 which utilizes soft object models for grain packing, e.g., exemplary soft spheres (see FIGS. 8A-8D) or other soft objects, such as some polyhedron (6-, . . . 12-, 14-, . . . 18-, 20-, . . . or more sided soft objects), that permits some degree of soft object overlap. The soft object model incorporates a methodology for the prediction of the final packing state of a clastic sediment (IGV_{f}) based on the packing of soft objects given a known or predicted grain size distribution. The soft object model is based on the idea that by allowing grains to overlap, the grains will be brought closer together and thereby reduce the IGV. This in turn will lead to an increase in the average number of grain contacts (coordination number) for each grain. Pack stability is achieved by balancing the packing force with the elastic forces at grain contacts. Packing forces act to push grains together, while contact forces tend to push grains apart. The present inventor has determined that this process, if correctly applied, is found to be self limiting, and is also dependent on the grain size distribution.

Referring to FIG. 3, the exemplary embodiment utilizes soft spheres as the designated objects that are modeled. As aforementioned, the present inventor has determined that there is currently no theory to predict IGV_{f} for packs of overlapping spheres. Therefore, a modeling approach is applied to determine porosity as a function of grain size distribution. Process 300 may be utilized to predict an end compaction point of a clastic sediment within a subsurface region. In step 310, a first grain size distribution is established. The first grain size distribution may be a measured grain size distribution, a predicted grain size distribution, or a combination of measured-predicted grain size distributions. In step 320, a discrete element model of the subsurface region is initialized. For example, the discrete element model (DEM) may include a model volume comprising a solid base, periodic horizontal boundaries, an open top, and soft objects representative of particles of the first grain distribution at a predetermined initial porosity. In step 330, a predicted packing state is predicted by running the DEM model from step 320. In step 330, the model is iteratively run, e.g., for a predetermined number of iterations or period of time thus cutting off the number of model iterations, to ultimately predict a final packing state of the clastic sediment based on packing of the soft objects with a pack and based on the first grain size distribution. In step 335, at each iteration, the predicted packing state and other model results are recorded. The soft objects, e.g., soft spheres, within the model are capable of overlapping with adjacent soft objects within the model. The degree of overlap may be preset to a maximum level, e.g., 0.06 or less, 0.05 or less, 0.04 or less, or even smaller, such as 0.006 or less amount of permissible object overlap. A final packing state of the clastic sediment is predicted in step 340, e.g., after the model has been run iteratively in steps 330 and 335.

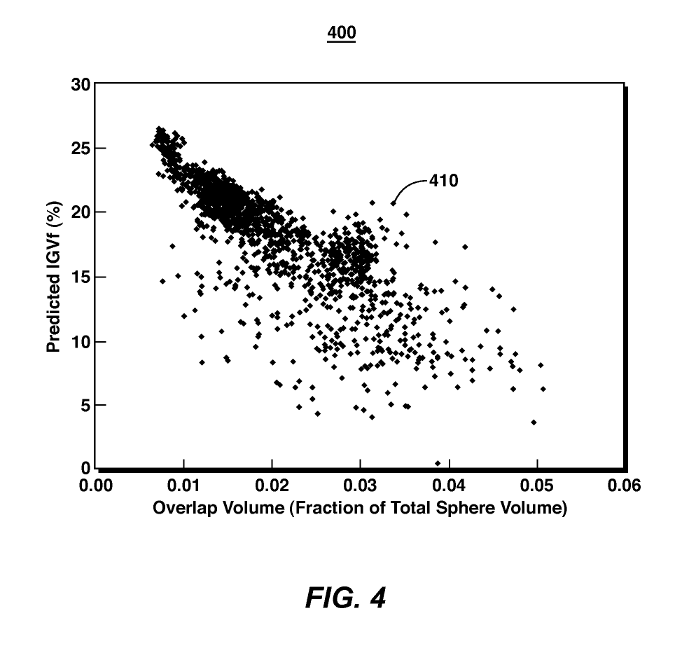

The practical effect of allowing soft object overlap in process 300 on IGV_{f} is shown in FIG. 4. FIG. 4 is a graphical view 400 of predicted final intergranular volume 410 plotted versus overlap volume for a test data set generated in accordance with the process of FIG. 3. Referring to FIG. 4, predicted/modeled IGV_{f} is plotted versus amount of sphere overlap for an exemplary test data set. The results in FIG. 4 demonstrate that IGV_{f} is a strong function of the degree of sphere overlap allowed. For example, for an allowed overlap of 0.04 of the sphere pack volume, the predicted IGV_{f} decreases by approximately 20 percent.

It is understood that variations may be made in the foregoing without departing from the scope and spirit of the invention. For example, one or more of the exemplary embodiments of this description provide one or more of the following advantages. First, the exemplary embodiments permit the effective application of a DEM to the problem of predicting IGV_{f} for a specified grain size distribution. For example, the application of soft objects, such as overlapping spheres, in the model to this problem has heretofore not been described or suggested in the background art. The soft object packing parameters may also be optimized for sphere overlap. One or more of the exemplary embodiments exploits the observation that soft object overlap, e.g., soft spheres, is self limiting and determined by the grain size distribution.

In an exemplary embodiment, process 300 may specifically apply specific discrete element models (DEM) based on the packing of various articles, such as spherical particles. See, e.g., Cundall, P. A. and O. Strack, 1979, A discrete numerical method for granular assemblies, Geotechnique, 29, 47-65. The model volume may include a solid base, periodic horizontal boundaries, and an open top or closed top. For example, the model volume may be such that when populated by non-overlapping spheres, the initial porosity may be set to be approximately 60 percent. In step 320, the model may be initialized with a number of spherical particles having a specified grain size distribution. For example, a preferred number of particles for the models may be selected, such as 1000 particles (or 500, 5,000, 10,000, or more particles) of varying sizes, and/or shapes. For example, the initialized model may include an initial configuration of hard spherical particles that assumes the particles are configured randomly, and may be non-overlapping (thus initially hard particles, not soft particles).

With respect to step 330, an exemplary model run may include the model may be iterated as follows. First, contact forces are calculated and summed for each particle. Contact forces are important as they act to separate grains. One of ordinary skill in the art will appreciate that there are several ways contact forces may be calculated. For example, one applicable method is based on Hertz theory:

$${F}_{c} = \frac{2}{3} \frac{{Ea}_{ij}^{3}}{{r}^{*} ( 1 - {v}^{2} )}$$

$$where \text{:}$$

$${a}_{ij} = \sqrt{( {r}_{1} {r}_{2} ) * ( 1.0 - d / ( {r}_{1} + {r}_{2} )}$$

$$and$$

$${r}^{*} = \frac{{r}_{1} {r}_{2}}{{r}_{1} + {r}_{2}}$$

The parameters are:

E=elastic modulus

v=Poisson's ratio

r₂ are the radii of the contacting grains (mm)

d=distance between the grain centers (mm).

For example, a preferred contact model is based on the volume of overlap:

$${F}_{c} = \frac{{EV}_{i}}{2 {r}_{i}}$$

where:

E=elastic modulus

Vᵢ=volume of overlap for sphere I (mm)

rᵢ=radius of sphere I (mm)

The foregoing model is preferable since the calculated contact force is comparatively weak for low amounts of grain overlap. Accordingly, the repulsive forces are typically decreased, which enables overlapping particles to continue overlapping for a number of iterations. The decreased repulsive force allows particles to squeeze past one another in the model. Once the contact forces have been summed for each particle, the forces are scaled by the maximum force recorded, and the particles are moved in proportion to the scaled forces.

Second, the compacting forces may be calculated for each particle. The compacting force in the model is due to gravity. Particles which are gravitationally stable may not fall or roll. For example, an exemplary test for stability involves checking all points of contact below the mid point of the spherical object in order to assess whether the sphere is fully supported. However, in one or more exemplary embodiments, this condition may be relaxed so that only the three lowermost contact points are examined to determine whether they constitute a supporting configuration. This has the effect of allowing some spheres to be considered unstable even though they are stable if a full stability condition were applied. The choice of stability condition, e.g., full or reduced, is a model parameter. If a full stability condition is used, the model generates packs with random close packing, e.g., IGV in the range of approximately 30 to 36%. In these packs, stable bridging structures are retained which can produce over-large pore spaces. If a reduced stability condition is used, the additional sphere motion causes a break up of bridging structures, and leads to a closer packing configuration.

The distance the sphere is allowed to fall or roll is also controlled through a model parameter which has an effect on the amount of sphere overlap preserved in the model. In one or more exemplary embodiments, this parameter is optimized during a model run to lead the pack to a specified target amount of grain overlap. In practice, it is found that packs stabilize before this target amount of overlap is reached, indicating a balance between elastic and gravitational forces, moderated by the grain size distribution, confirming the idea that the overlap is self limiting. By specifying a small value for the target overlap, e.g. less than or equal to 0.001%, the model is able to reproduce literature results for uni-modal, bi-modal and log-normal packs of hard spheres, e.g., Nolan and Kavanagh, 1992; 1993; 1994 referenced hereinabove.

Throughout the model run, the calculated porosity may also be monitored over a specified section of the pack, e.g., not necessarily monitored over the entirety of the pack. In one or more exemplary embodiments the porosity may be calculated over the range 0.2 to 0.45 fraction of the sphere pack height. By limiting the section of the pack to be monitored throughout model iterations, the effects of the base and top boundary conditions may be avoided if desired.

As aforementioned, the model may be run for a specified number of iterations. In one or more exemplary embodiments, the maximum number of model iterations may be set to 500, 1000, 2500, 10000, 25000, or any desirable number of iterations. The minimum porosity and conditions of the pack at the minimum porosity are recorded. By using comparatively few iterations, the packing algorithm will be extremely efficient, and may achieve an optimum packing configuration within several thousand iterations, e.g., 2500 iterations or less. Second, more iterations give time for the smaller grains to percolate through the pack toward the base of the model, thereby producing a size segregation, e.g., widely known as the Brazil nut effect, where the larger particles tend to float on the smaller particles. In this state, the smaller particles are not engaged in the packing arrangement. In one or more exemplary embodiments a preferred technique is to run the model multiple times for each sediment grain size distribution, in order to assess the variability of the model output.

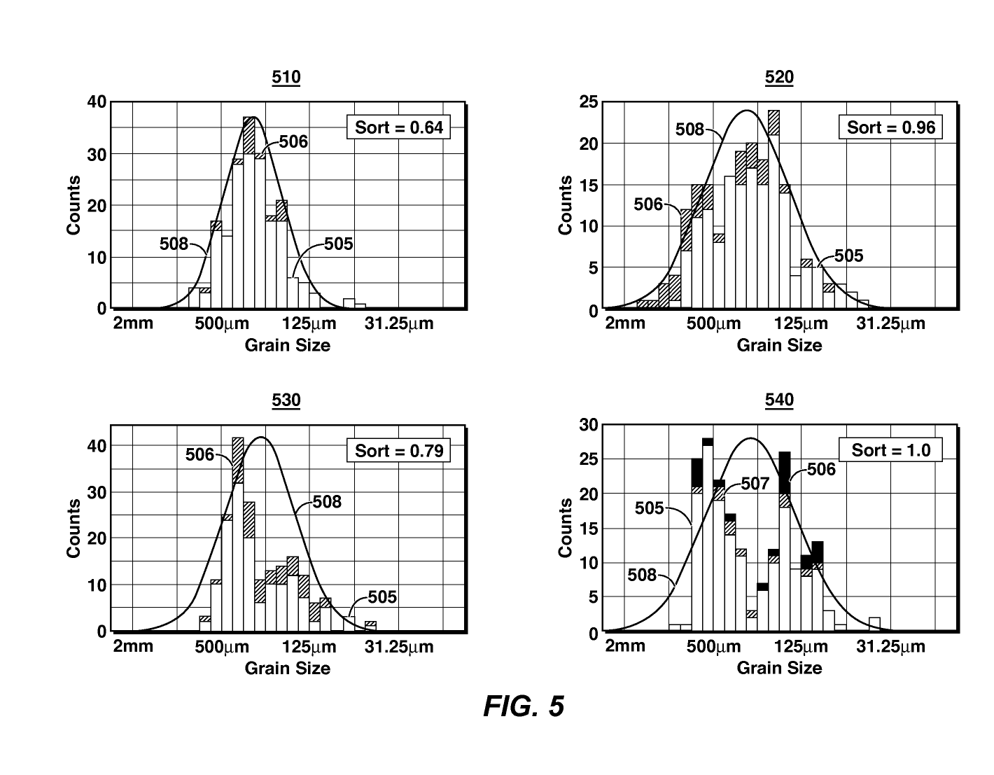

FIG. 5 are graphical views of exemplary grain size distributions for a given sorting value (Folk sorting parameter). Referring to FIG. 5, the example depicted in FIG. 5 is of Permian eolian dune sands of the German Rotliegendes, collected from 4500˜4700 m depth. Exemplary grain size distributions 510, 520, 530, 540 for each of the examples discussed include a sorting value, e.g., 0.64, 0.79, 0.96, and 1.0, given is the Folk sorting parameter, and the standard deviation of the grain size in log 2 units. Some of the diverse grain size distributions 510, 520, 530, 540 present in this dataset are shown in FIG. 4. Also plotted on each of the sort views 510, 520, 530, 540 of FIG. 5 are log-normal distributions curves 508 to demonstrate the extent to which these distributions deviate from log-normal. The quartz counts 505, lithics counts 506, and feldspar counts 507 are shown where appropriate on each sort view 510, 520, 530, and 540. The sample suite represents a wide range of grain size distributions, from nearly log-normal (Folk sorting=0.64), skewed to large size fraction (Folk sorting=0.96), skewed to fine size fraction (Folk sorting=0.79), to bimodal (Folk sorting=1.0).

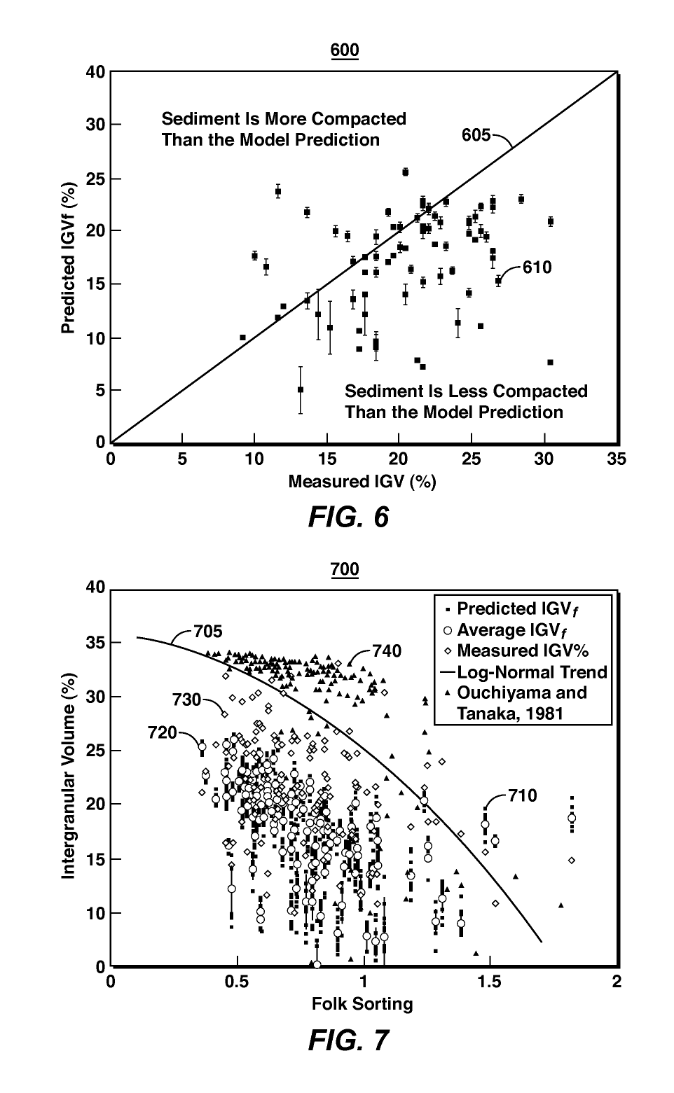

Results from an exemplary DEM soft sphere compaction model are shown in FIGS. 6 and 7. FIG. 6 is a graphical view 600 of predicted final intergranular volume 610 plotted versus measured intergranular volume. Referring to FIG. 6, predicted IGV_{f} (y-axis) versus measured IGV (x-axis) is shown for samples from this dataset. Two fields are indicated on the plot separated by the 1:1 line 605. Samples plotting to the upper left of the 1:1 line 605 have a lower measured IGV than predicted by the model, e.g., the samples are more compacted than the model would predict. Samples plotting to the lower right of the 1:1 line 605 indicate that the measured sample IGV is greater than the model prediction for IGV_{f}, e.g., they are less compacted than the model would predict. Samples in this field are suitable for calibrating forward models, e.g. Lander, R. H. and O. Walderhaug, 1999, Predicting porosity through simulating sandstone compaction and quartz cementation, Amer. Assoc. Petrol. Geol. Bull., 83, 433-449, since these models consider the effect of pore filling cements in retarding compaction.

FIG. 7 is a graphical view 700 of intergranular volume (predicted IGV 710 and average IGV 720) plotted versus Folk sorting for results obtained by the process of FIG. 1, measured intergranular volume 730, and showing the log-normal trend 705. Referring to FIG. 7, the model calculation 710, 720 of IGV_{f} is plotted versus Folk sorting, and compared to measured values 730, the Ouchiyama and Tanaka (1981) log-Normal model curve 705, and values for IGV calculated using Ouchiyama and Tanaka's technique 740. The model's predicted results 710 and measured IGV 720 values fall well below the log-normal curve, and also below the values calculated using Ouchiyama and Tanaka's technique 740, e.g., thus further demonstrating the effectiveness of the IGV-Sorting relationship predicted by the exemplary embodiments.

FIGS. 8A-8D are screenshots depicting predicted packing states obtained after running a discrete element model of approximately 1000 spherical objects of various sizes (large particles 805, medium particles 806, and smaller particles 807) for a variety of sequential iterations. FIG. 8A shows a pack 810 after no iterations, with an initial porosity of 59%, e.g., similar to the initialized model described in step 320. FIG. 8B shows a pack 820 after 1000 iterations, with a predicted porosity of 30%. FIG. 8C shows a pack 830 after 2100 iterations, with a predicted porosity of 20%. FIG. 8D shows a pack 840 after 5000 iterations, with a predicted porosity of 19%. As seen in the sequential packs 810-840 of FIGS. 8A-8D, the various particles 805, 806, 807 eventually settle lower and more tightly within the pack after compacting and contact forces are calculated after the multiple iterations.

It is understood that variations may be made in the foregoing without departing from the scope and spirit of the invention. For example, one or more of the aforementioned embodiments can include multiple processes that can be implemented with computer and/or manual operation. One or more of the aforementioned embodiments can comprise one or more computer programs that embody certain functions described herein and illustrated in the examples, diagrams, figures, and flowcharts. However, it should be apparent that there could be many different ways of implementing aspects of the present invention with computer programming, manually, non-computer-based machines, or in a combination of computer and manual implementation. The aforementioned embodiments should not be construed as limited to any one set of computer program instructions. Further, a programmer with ordinary skill would be able to write such computer programs without difficulty or undue experimentation based on the disclosure and teaching presented herein.

Therefore, disclosure of a particular set of program code instructions is not considered necessary for an adequate understanding of how to make and use the exemplary embodiments. The functionality of any programming aspects of the exemplary embodiments will be explained in further detail in the following description in conjunction with the figures illustrating the functions and program flow and processes.

For example, a tangible computer-readable storage medium having embodied thereon a computer program configured to, when executed by a processor, a method for predicting an end compaction point of a clastic sediment within a subsurface region, the method including establishing a first grain size distribution, wherein the first grain size distribution is a measured grain size distribution or a predicted grain size distribution; initializing a discrete element model of the subsurface region, wherein the model comprises a model volume comprising a base, horizontal boundaries, and soft objects representative of particles of the first grain distribution at a predetermined porosity; and predicting, by iteratively running the model, a final packing state of the clastic sediment based on packing of the soft objects with a pack and based on the first grain size distribution, wherein soft objects within the model are capable of overlapping with adjacent soft objects within the model. The tangible computer-readable medium may be utilized to output, e.g., through a display device or into a subsequent modeling or data processing technique, a model of subsurface porosity and grain size distribution after multiple iterations of the aforementioned model.

The tangible computer-readable storage medium may include one or more code segments configured to perform one or more of the following functions. For example, the tangible computer-readable medium may include code segments configured to determine a volume of hydrocarbons within a subsurface region, to determine a maximum available porosity capable of containing hydrocarbons in the clastic sediment based on the determined end compaction point, to determine a maximum porosity of the sediment at a plurality of depths in the subsurface region using an initial compaction porosity and a final predicted compaction porosity, and compaction laws, and/or to estimate a hydrocarbon volume within the subsurface region based on the determined maximum porosity. The compaction laws may include exponential compaction with increasing depth or effective stress. A volume of producible hydrocarbons within the subsurface region may be estimated based on the estimated hydrocarbon volume. Hydrocarbons may also be produced from the subsurface region based on the estimated volume of producible hydrocarbons from the tangible computer-readable medium.

An exemplary process for determining an end compaction point of a clastic sediment within a subsurface region would include predicting the end compaction point by establishing a first grain size distribution. The first grain size distribution is a measured grain size distribution, a predicted grain size distribution, and/or a combination of measured and predicted grain size distribution. A discrete element model of the subsurface region is initialized. The model may include a model volume having a base, horizontal boundaries, and soft objects representative of particles of the first grain distribution at a predetermined porosity. A final packing state of the clastic sediment is predicted by iteratively running the model based on packing of the soft objects with a pack and based on the first grain size distribution. The soft objects within the model are capable of overlapping with adjacent soft objects within the model. A maximum available porosity capable of containing hydrocarbons in the clastic sediment is determined based on the determined end compaction point. A maximum porosity of the sediment may be determined at a plurality of depths in the subsurface region using an initial compaction porosity and a final predicted compaction porosity, and compaction laws. A hydrocarbon volume may be estimated within the subsurface region based on the determined maximum porosity.

In one or more of the aforementioned aspects, the compaction laws may include exponential compaction with increasing depth or effective stress. A volume of producible hydrocarbons within the subsurface region may be estimated based on the estimated hydrocarbon volume. Hydrocarbons may be produced from the subsurface region based on the estimated volume of producible hydrocarbons.

The final packing state may be displayed, e.g., a model of the final pack may be shown on a display device or printed, or the final porosity of the packing state may be determined from the final packing state and utilized in other modeling processes, e.g., for reservoir characterization. The model, after one or more of the iterations, may be stored on a tangible computer readable medium and/or displayed or otherwise output through a display device or printer. For example, representations of the model, such as during various iterations shown in FIGS. 8A-8D, may be displayed on a computer display device and/or printed. Some portions of the detailed description herein may be implemented by a software implemented process involving symbolic representations of operations on data bits within a memory in a computing system or a computing device. The descriptions and representations of the foregoing embodiments are the means used by those in the art to most effectively convey the substance of their work to others skilled in the art. However, the process and operations associated with the foregoing embodiments require physical manipulations of physical quantities, e.g., grain size distributions are representations of a physical system and the models represent transformations of the physical system. These physical quantities may take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Although illustrative embodiments of the present invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope and spirit of the invention.

What is claimed is:

1. A method for predicting an end compaction point of a clastic sediment within a subsurface region, comprising:
establishing a first grain size distribution, wherein the first grain size distribution is a measured grain size distribution or a predicted grain size distribution;
initializing a discrete element model of the subsurface region, wherein the model comprises a model volume comprising a base, horizontal boundaries, and soft objects representative of particles of the first grain distribution at a predetermined porosity; and
predicting, by iteratively running the model, a final packing state of the clastic sediment based on packing of the soft objects with a pack and based on the first grain size distribution, wherein soft objects within the model are capable of overlapping with adjacent soft objects within the model.

2. The method according to claim 1, wherein iteratively running the model comprises calculating elastic contact forces and summing elastic contact forces for each particle.

3. The method according to claim 2, wherein the soft objects are representative of one or more grains and are permitted to overlap with adjacent soft objects.

4. The method according to claim 1, wherein running the model comprises calculating a compacting force due to gravity for each particle in the model.

5. The method according to claim 2, wherein running the model comprises calculating a compacting force due to gravity for each particle in the model.

6. The method according to claim 5, further comprising balancing the compacting forces with the elastic forces at grain contacts to achieve a predetermined packing stability.

7. The method according to claim 6, further comprising calculating porosity over a specified section of the pack for each iteration of the model run, wherein porosity is calculated as a function of grain size distribution and based on the final packing state.

8. The method according to claim 7, further comprising storing the calculated porosity over the specified section of the pack for each iteration of the model run.

9. The method according to claim 7, wherein the specified section of the pack for which porosity is calculated range from 0.2 fraction of the pack height to 0.45 fraction of the pack height to avoid the effects of base and top boundary conditions.

10. The method according to claim 2, further comprising balancing the compacting forces with the elastic forces at grain contacts to achieve a predetermined packing stability.

11. The method according to claim 10, wherein the predetermined packing stability is determined by checking all points of contact below the mid point of the soft object in order to assess whether the soft object is fully supported.

12. The method according to claim 11, wherein only three lowermost contact points for each soft object are examined to determine whether the three lowermost contact points constitute a supporting configuration for each soft object.

13. The method according to claim 11, wherein the predetermined packing stability is a selected model condition.

14. The method according to claim 13, further comprising selecting a full stability condition for generating a random close packing with the model.

15. The method according to claim 13, further comprising selecting a reduced stability condition for generating a random close packing with the model.

16. The method according to claim 2, further comprising calculating porosity over a specified section of the pack for each iteration of the model run.

17. The method according to claim 16, further comprising storing the calculated porosity over the specified section of the pack for each iteration of the model run.

18. The method according to claim 17, wherein the model is run for a specified number of iterations.

19. The method according to claim 18, wherein the specified number of iterations is approximately 25,000 iterations or less.

20. The method according to claim 18, wherein the specified number of iterations is 2,500 iterations or less.

21. The method according to claim 2, further comprising:
recording the minimum porosity and conditions of the pack at the minimum porosity at each iteration while running the model; and
setting a fraction of total object overlap volume for at least one of the iterations.

22. The method according to claim 21, wherein the soft objects are soft spheres, soft cells, or soft polyhedrons, and the fraction of total object overlap volume is set at 0.05 or less.

23. The method of claim 21, wherein the model volume comprises a solid base, periodic horizontal boundaries, an open top, and soft spherical objects representative of particles of the first grain distribution at a predetermined initial porosity.

24. A method of determining a volume of hydrocarbons within a subsurface region, comprising:
determining an end compaction point of a clastic sediment within a subsurface region, wherein predicting the end compaction point includes:
establishing a first grain size distribution, wherein the first grain size distribution is a measured grain size distribution or a predicted grain size distribution;
initializing a discrete element model of the subsurface region, wherein the model comprises a model volume comprising a base, horizontal boundaries, and soft objects representative of particles of the first grain distribution at a predetermined porosity; and
predicting, by iteratively running the model, a final packing state of the clastic sediment based on packing of the soft objects with a pack and based on the first grain size distribution, wherein soft objects within the model are capable of overlapping with adjacent soft objects within the model;
determining a maximum available porosity capable of containing hydrocarbons in the clastic sediment based on the determined end compaction point;
determining a maximum porosity of the sediment at a plurality of depths in the subsurface region using an initial compaction porosity and a final predicted compaction porosity, and compaction laws; and
estimating a hydrocarbon volume within the subsurface region based on the determined maximum porosity.

25. The method according to claim 24, wherein the compaction laws comprise exponential compaction with increasing depth or effective stress.

26. The method according to claim 24, further comprising estimating a volume of producible hydrocarbons within the subsurface region based on the estimated hydrocarbon volume.

27. The method according to claim 26, further comprising producing hydrocarbons from the subsurface region based on the estimated volume of producible hydrocarbons.
